(19) United States
(12) Patent Application Publication
(10) Pub. No.: US 2004/0074664 A1
(43) Pub. Date: Apr. 22, 2004

(54) Energy transfer system for a three-phase current in the average and a high tension range

(76) Inventors: Jens-Peter Jensen, Hamburg (DE); Dieter Konig, Darmstadt (DE); Josef Hanson, Darmstadt (DE); Frank Hoertz, Worms (DE)

Correspondence Address: NIXON & VANDERHYE, PC, 1100 N GLEBE ROAD, 8TH FLOOR, ARLINGTON, VA, 22201-4714, US

(21) Appl. No.: 10/433,957

(22) PCT Filed: Nov. 20, 2001
(86) PCT No.: PCT/EP01/13439

(30) Foreign Application Priority Data
Dec. 7, 2000 (DE) 100 60 923.6

(51) Int. Cl. H01B 1/00

(52) U.S. Cl. 174/68.1

(57) ABSTRACT

The invention relates to an energy transfer system for three-phase current in the average and a high tension range, comprising at least one conductive piece which has at least three cylindrical conductors which are electrically insulated from each other and arranged in a concentric manner. The aim of the invention is to produce an energy transfer system which does not produce magnetic fields in an external area and which has low installation costs. According to the invention, at least one connector part can be connected to the at least one conductive part, in order to link or branch said conductive parts. The connector piece (40) is provided with corresponding cylindrically arranged conductors (41, 42, 43) which are insulated from each other, whereby the diameters thereof correspond to the diameters of the cylindrical conductors (21, 22, 23) in the conductive part (20) in such a way that they can slid in an electrical contacting manner similar to that of a sliding bushing for connection onto a corresponding respective cylindrical conductor of the conductive part. All conductors (21, 22, 23, 41, 42, 43) are embodied as tube gas conductors for insulation with insulating gas. The sliding connection of the outer lying cylindrical conductors (23, 43) is embodied as a gastight connection.

The invention relates to an energy transfer system for three-phase current in the medium- and high-voltage range with at least one line piece which has at least three cylindrical conductors which are electrically insulated from one another and arranged in a concentric manner.

Such an energy transfer system is known from DE-B 1 026 385, in which a multi-wire electric power cable is described. The cable has a core conductor in the form of a seamless aluminum strand, which is followed by an insulating layer 2 of a thermoplastic material. The insulating layer is followed in the radial direction by a second conductor in the form of an aluminum tube, a further layer of plastic for insulation, a third conductor in turn in the form of an aluminium tube, a further insulating layer and a fourth, tubular conductor serving as a neutral or ground conductor. The tubular conductors are arranged concentrically in relation to one another.

On the other hand, so-called gas-insulated conductors or tubular gas conductors are known in medium- and high-voltage technology. Known gas-insulated conductors for three-phase current have three conductor tubes, which are arranged lying next to one another within an enclosing tube which is filled with gas, for example SF₆ or N₂. The locational shift of the current components in the three conductors has the effect that the magnetic fields are superposed on one another in the external area, so that complete compensation is not possible. Outside the conductors, there is always a magnetic field other than zero.

In many application areas, however, magnetic fields are to be avoided as completely as possible. For example, in experiments involving high-energy physics, in which high levels of electric power have to be transported in an accelerator tunnel, magnetic fields emanating from energy transfer systems are very critical, since the sensitive control of the radiation of the charged particles in the actual accelerator beam tube is disturbed even by minimal external magnetic fields. When supplying energy for modern, sensitive experiments, it is endeavored (with transferred currents of the order of 1000 A and voltages of the order of 10 kV) to keep the resultant magnetic fields at a distance of 1 m below 200 nT. Corresponding requirements for extremely low residual magnetic fields also arise, however, in other application areas, such as for example medical technology. Even in the case of lines of power supply companies, minimization of magnetic fields in the external area is desirable to prevent possible harmful effects of electromagnetic fields.

DE 63072 B discloses an energy transfer system in the form of an electricity conductor which has at least one line piece which has three cylindrical conductors which are electrically insulated from one another and arranged in a concentric manner, the outer conductor serving however as a protective sheath and to this extent not being intended to carry current. Furthermore, there is at least one connector piece, which can be connected to the at least one line piece, for connecting or branching line pieces, there being present in the connector piece corresponding concentrically arranged conductors, the diameters of which are made to match the cylindrical conductors of the line piece in such a way that they can be pushed in an electrically contacting way in the manner of a sliding bushing onto the corresponding respective cylindrical conductor of the line piece for connection. Between the conductors there is air, so that the conductors are formed as tubular gas conductors formed with air as the insulating gas.

EP 0 788 208 A2 discloses an energy transfer system for three-phase current in the medium- and high-voltage range which has at least one line piece with at least three cylindrical conductors which are electrically insulated from one another and arranged in a concentric manner. In this case there are connector pieces for connecting the conductors of the line pieces, each connector piece having a corresponding concentrically arranged conductor, the diameter of which is made to match the corresponding cylindrical conductor in such a way that they have the same diameter. However, the connector pieces of the individual conductors are arranged independently of one another and at different axial positions in the longitudinal direction of the assembly of line pieces. All the conductors are formed as tubular gas conductors to be insulated with insulating gas. Furthermore, at least the connections of the outer cylindrical metal encapsulations are designed as a gastight connection. However, the known system does not allow the use of prefabricated line pieces, since the individual concentric conductors have to be connected independently of one another in situ. Furthermore, no possibilities are provided for branching from a concentric tubular gas conductor into a concentric tubular gas conductor.

CH 557 100 discloses an electrical high-voltage device with electrodes which are kept at a distance from one another coaxially by a disk-shaped insulator and between which there is a fluid as an insulating agent. The pin insulators taper in the radial direction from the inside outward. The pin insulators are, furthermore, provided on their inner and outer surfaces with a peripheral groove, in which shielding electrodes, i.e. high-impedance but conductive elements, are placed in order to reduce electrical predischarges, in particular current filament discharges.

It is the object of the present invention to provide an energy transfer system for three-phase current which allows electrical energy to be transferred without magnetic fields in the external area, it being intended to ensure easy handling during the construction and assembly of the transfer links.

The characterizing features of claim 1 in conjunction with its precharacterizing clause serve for achieving this object. Advantageous embodiments of the invention are specified in the subclaims.

According to the invention there is at least one connector piece which can be connected to the at least one line piece, which has three cylindrical conductors which are electrically insulated from one another and arranged in a concentric manner, for connecting or branching line pieces. In the connector piece there are, corresponding to the conductors of the line piece, concentrically arranged cylindrical conductors which are insulated from one another, the diameters of which are made to match those of the cylindrical conductors in such a way that they can be pushed in an electrically contacting way in the manner of a sliding bushing over the corresponding respective cylindrical conductors of the line piece for connection. Furthermore, all the conductors are formed as tubular gas conductors, the sliding connection of the outer cylindrical conductors being designed as a gastight connection.

The concentric arrangement of the cylindrical conductors has the effect that the magnetic field vectors of all the conductors spatially coincide. Therefore, the magnetic fields of the three-phase current components completely cancel one another out on account of their phase shifts. On the other hand, the transfer system offers all the advantages of gas-insulated conductors, while it is nevertheless possible with the arrangement according to the invention to construct energy transfer systems with relatively little effort by assembling a number of line pieces which are connected to one another by connector pieces, in that the modules (line pieces, connector pieces) are connected to one another in the manner of sliding bushings.

Line pieces and connector pieces may be provided with three concentric conductors, the three-phase current system then being operated in such a way that it is grounded on one side. On the other hand, a fourth concentric conductor may also be provided and operated as a neutral conductor.

The energy transfer system is suitable for transferring electrical energy in the high-voltage and medium-voltage range and is suitable for operation with voltages from approximately 10 kV up to 100 kV, it being possible for the currents to be in the range from approximately 100 A up to several thousand amperes.

In an advantageous embodiment, for easy closing of the sliding connection between a line piece and a connector piece, clamping levers are provided on one of the outer conductors and clips for engagement by the clamping levers are provided on the other conductor, so that, by turning the clamping levers, the connector piece and the line piece are pushed one into the other with a predetermined force and in this way the corresponding cylindrical conductors are respectively pushed one into the other in the manner of sliding bushings, and in this way are brought into electrical contact with each other.

In an advantageous embodiment, in the overlapping region of the sliding connection of each and every pair of conductors there is provided on the circumference a peripheral groove, which faces the other conductor of the pair of conductors and into which there is placed a peripheral spiral contact, which also touches the other conductor in order in this way to improve the electrical contact of the pair of conductors. In this way it is possible for the sliding connection to leave in the overlapping region a small interspace between the facing conductor surfaces and for the electrical contact to be established by the spiral contact touching the two conductors.

As a result, damage to the surfaces, which could be disadvantageous for the integrity of the connection, can be avoided when the conductors are pushed one into the other.

In an advantageous embodiment, the gastight connection of the outer conductors of a connector piece and a line piece is realized by a peripheral recess in the overlapping region of the conductors, with a sealing ring placed in it.

In order to keep the cylindrical conductors in a line piece in position concentrically in relation to one another, provided in a preferred embodiment are annular pin insulators, which are preferably formed from cured epoxy resin. The annular pin insulators are pushed with a sliding fit onto the inner conductors and extend through the annular interspace to the next outer conductor, against the inner wall of which they bear.

The pin insulators preferably taper in the radial direction from the inside outward, i.e. their thickness decreases outward. This shaping of the pin insulators serves for optimizing the distribution of the electric field on the insulator surface. Furthermore, the pin insulators are preferably provided on their cylindrical inner and outer surfaces with a peripheral groove, into which a high-impedance, but conductive element is placed in order to establish electrical contact between the conductor onto which the pin insulator has been pushed and the pin insulator. As a result, gap discharges, which could otherwise occur in the minimal gap between the conductor and the pin insulator, can be avoided.

Also provided, in a preferred embodiment, are annular bulkhead insulators, which have been pushed onto the inner conductors of the line piece or of the connector piece and completely fill the annular interspace between an inner conductor and the next outer conductor, a peripheral groove respectively being provided in the touching surfaces between the bulkhead insulators and the adjacent conductors, which groove respectively bears a peripheral sealing ring in order in this way to form a gastight termination. Bulkhead insulators of this type are preferably provided at least near the ends of each line piece, in order to isolate the interior spaces of interconnected line pieces from one another with regard to gas throughflow.

In a preferred embodiment, a connector piece for branching a line piece is formed from a connector piece for connecting two line pieces and a T line piece connected thereto. The cylindrical conductors of the T line piece coincide in construction and dimensions with those of a normal line piece and have a stub in which a cylindrical conductor with the same diameter branches off from each cylindrical conductor, substantially at right angles.

Furthermore, in a preferred embodiment there may be end pieces. Each end piece coincides at one end in the construction and dimensions of the concentric cylindrical conductors with a connector piece and is terminated at the other end by being led out suitably with field control.

With the system according to the invention it is possible in an easy way to construct electrical transfer routes with gas-insulated conductors in an arrangement which produces only minimal external magnetic fields, in that line pieces and connector pieces are connected to one another in a conducting manner. In this case, a gastight termination of the outer conductor is achieved. If need be, each conductor may be individually sealed off in a gastight manner. In this way it is possible with relatively little installation effort to construct energy transfer systems with gas-insulated conductors.

The invention is described below on the basis of exemplary embodiments in the figures, in which:

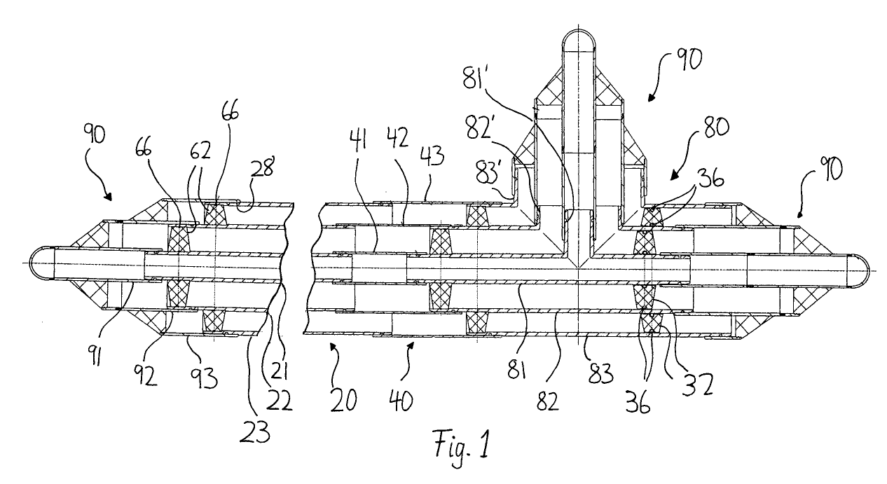

FIG. 1 shows a cross-sectional view of part of a line piece with a connector piece connected to it and a T line piece;

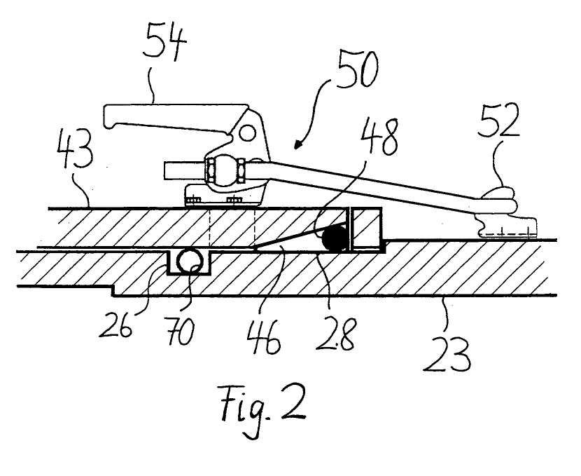

FIG. 2 shows an enlarged cross-sectional representation of the outer conductors of a sliding connection;

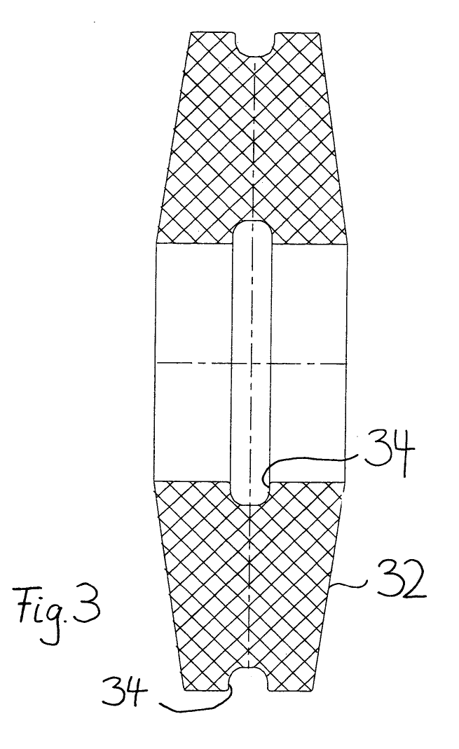

FIG. 3 shows a pin insulator in section;

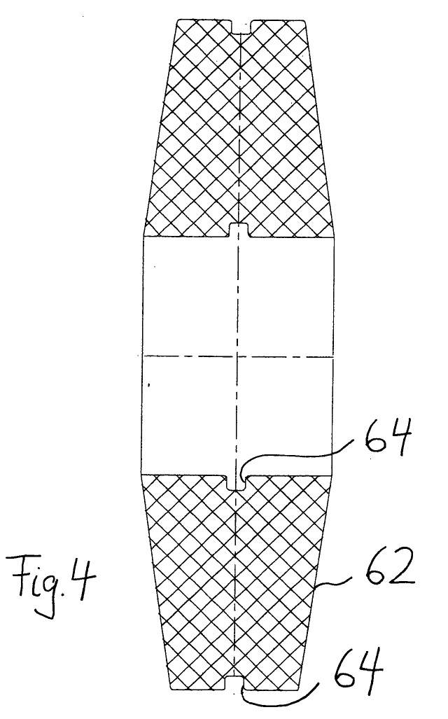

FIG. 4 shows a bulkhead insulator in lateral section.

FIG. 1 shows an energy transfer system with a line piece 20 (shown greatly shortened for representational reasons), which is connected to a connector piece 40, to which in turn a T line piece 80 is connected. End pieces 90 are attached to the ends of the lines in this schematic example.

The line piece 20 has three concentrically arranged, cylindrical conductors 21, 22 and 23. The concentric arrangement of the conductors 21, 22 and 23 is retained by pin insulators 32. The pin insulators 32, which are shown enlarged in FIG. 3, are annular bodies which are formed from a solid insulating material, preferably from cured epoxy resin. The pin insulators 32 are pushed with a sliding fit onto the respective conductor which they surround, and then fill the interspace with respect to the next conductor lying further to the outside. Provided on the pin insulators 32 on the surfaces facing the adjacent conductors are peripheral grooves 34, into which a conductive element 36 has been respectively placed. The conductive element has high impedance, but is conductive, in order in this way to establish electrical contact between the conductor and the adjacent pin insulator. This electrical contact is required in order to prevent possible discharges which [lacuna] in the small gap which may remain between the pin insulator and the adjacent conductor. A plurality of pin insulators 32 may be provided along the length of a line piece 20.

Provided along with the pin insulators 32, at least near the ends of the line piece 20, are bulkhead insulators 62, which may likewise be formed by annular bodies of cured epoxy resin and are shown enlarged in FIG. 4. In the end regions of the line piece 20 envisaged for bulkhead insulators 62, the conductor surfaces against which the bulkhead insulators 62 are to bear are machined down slightly, so that the bulkhead insulators 62, which have a slightly greater height than the pin insulators 32, can be pushed into these machined-down regions. On the surfaces facing the conductors, the bulkhead insulators 62 are provided with peripheral grooves 64, into which a sealing ring 66 has been respectively placed, in order in this way to realize a gastight termination of the interspaces between the conductors 21, 22, 23. If bulkhead insulators 62 are also to be fitted away from the ends of the line piece 20, the surfaces of the conductors must have been machined down, at least from one end, over the entire distance up to the end in order to make it possible for the bulkhead insulators 62 to be pushed in.

Connected to the line piece 20 is a connector piece 40, which likewise has three concentric, cylindrical conductors 41, 42 and 43. The conductors 41, 42 and 43 correspond to the conductors 21, 22 and 23, respectively, of the line piece 20. The corresponding conductors 41, 42, 43 are adapted in their dimensions to the conductors 21, 22, 23 in such a way that they can respectively be pushed onto the conductors of the line piece 20 in the manner of a sliding bushing, so that an overlapping region is respectively obtained between the pairs of conductors 21 and 41, 22 and 42, and also 23 and 43. In the embodiment represented, the corresponding conductors 41, 42 and 43 are formed with a greater diameter than the conductors 21, 22 and 23 of the line piece, so that they push themselves over the conductors of the line piece on the outside. In this case, the conductors of the line piece 20 may be formed in the envisaged overlapping region with a depression, i.e. with reduced diameter, as shown in the representation of a detail in FIG. 2 for the outer pair of conductors 23 and 43. Here, the outer surface of the conductor 23 is designed with a region 28 with reduced outside diameter, over which the conductor 43 can be pushed. Corresponding regions 28 with reduced outside diameter are also provided on the inner conductors 21 and 22.

Also represented in FIG. 2 is the configuration of the gastight connection between the outer conductors 23 and 43. In the embodiment represented, the gastight connection is realized by the outer conductor 43 being provided with a recess 46, into which a sealing ring 48 has been placed. The sealing ring 48 is clamped between the line piece 20 and the connector piece 40 in the recess 46 when the connection is closed, so that it provides a gastight termination.

For closing the sliding connection between the connector piece 40 and the line piece 20, the clamping lever arrangement 50 represented in FIG. 2 is provided. The clamping lever arrangement 50 acts on a clip 52 on the line piece 20, so that the sliding connection between the connector piece 40 and the line piece 20 is closed by pressing down of the lever 54. In this way, during installation of the energy transfer system, the line pieces and connector pieces placed one against the other can be connected to one another in a simple way by the sliding-bushing connection provided, a gastight seal already taking place at the same time. Furthermore, the pushing of one into the other also has the effect at the same time of establishing the electrical contact between the pairs of conductors 2141, 22-42 and 23-43.

For establishing the electrical contact, the following measures are provided. Since the line pieces 20 and connector pieces 40 are intended to be easily able to be pushed one into the other, the diameters of the corresponding conductors are dimensioned in the overlapping region in such a way that, with the nominal diameters, a certain predetermined distance remains between the conductors in the overlapping region. This is necessary in order that, even with the customary production tolerances, jamming of a sliding connection cannot occur. In order nevertheless to achieve good electrical contact between the corresponding conductors 21 and 41, 22 and 42, and 23 and 43, a peripheral groove 26 is respectively provided in the overlapping region on one of the conductors of each pair of conductors, in the exemplary embodiment represented on the inner conductor 21, 22 and 23, placed into which groove is a spiral contact 70, which is in contact with both conductors of the respective pair of conductors 21 and 41, 22 and 42 and 23 and 43, and in this way provides good electrical contact between the conductors.

Also represented in FIG. 1 is a connector piece for branching a line piece 20. This connector piece comprises one of the previously described connector pieces 40 for connecting line pieces 20 and a T line piece 80 connected thereto. The T line piece 80 represented is constructed at its ends in the same way as a line piece 20 with three concentric conductors 81, 82 and 83, which can be held by pin insulators 32 and bulkhead insulators 62. Extending from each of the cylindrical conductors 81, 82 and 83 there is in the center a cylindrical conductor 81′, 82′ and 83′ with the same diameter. To this concentric conductor arrangement 81′, 82′, 83′ there can then in turn be connected, via a connector piece 40, a line piece 20 or, as in the exemplary embodiment represented, an end piece 90.

An end piece 90 has a concentric conductor arrangement, which corresponds to that of a connector piece 40. In the same way as a connector piece 40, the end piece 90 can therefore be pushed onto the end of a line piece 20 or, as in the exemplary embodiment represented, onto the end of the T line piece 80. At the opposite end, the end piece 90 is terminated by being led out suitably with field control.

In the exemplary embodiment represented, only three concentric conductors are provided. Such an arrangement is possible if the three-phase current system is operated in such a way that it is grounded on one side. In other embodiments, a fourth cylindrical conductor may also be provided and operated as a neutral conductor.

1. An energy transfer system for three-phase current in the medium- and high-voltage range with at least one line piece which has at least three cylindrical conductors which are electrically insulated from one another and arranged in a concentric manner, characterized in that there is at least one connector piece (40), which can be connected to the at least one line piece (20), for connecting or branching line pieces, there being present in the connector piece (40) corresponding concentrically arranged cylindrical conductors (41, 42, 43), which are insulated from one another and the diameters of which are made to match those of the cylindrical conductors (21, 22, 23) of the line piece (20) in such a way that they can be pushed in an electrically contacting way in the manner of a sliding bushing onto the corresponding respective cylindrical conductor (21, 22, 23) of the line piece (20) for connection, and in that all the conductors (21, 22, 23, 41, 42, 43) are formed as tubular gas conductors to be insulated with insulating gas, at least the sliding connection of the outer cylindrical conductors (23, 43) being designed as a gastight connection.

2. The energy transfer system as claimed in claim 1, characterized in that the gastight connection has a sealing ring (48) placed in a peripheral recess (46) in the overlapping region of the sliding connection of the outer cylindrical conductors (23, 43).

3. The energy transfer system as claimed in one of the preceding claims, characterized in that, for closing the sliding connection, a clamping lever (50) is provided on one of the outer conductors and a clip (30) for engagement by the clamping lever (50) is provided on the other conductor of the sliding connection, so that, by shifting the clamping lever (50), the sliding connection between the line piece (20) and the connector piece (40) can be closed with a predetermined force.

4. The energy transfer system as claimed in one of the preceding claims, characterized in that, in the overlapping region of the sliding connection of each pair of conductors (21, 41; 22, 42; 23, 43) of a pushed-together line piece (20) and connector piece (40), there is provided in one of the conductors on the circumference a peripheral groove (26), into which there is placed a peripheral spiral contact (70), which also touches the other conductor in order in this way to improve the electrical contact of the pair of conductors (21, 41; 22, 42; 23, 43).

5. The energy transfer system as claimed in claim 4, characterized in that the cylindrical conductors (21, 22, 23) of the line piece (20) are formed at the ends with a region (28) with reduced diameter of the outer wall, and in that the inside diameter of the conductors (41, 42, 43) of the connector piece (40) are adapted to these reduced outside diameters, so that each conductor (41, 42, 43) of the connector piece (40) is pushed on in the manner of a sliding bushing over the region with reduced outside diameter of the corresponding conductor (21, 22, 23) of the line piece (20) when the connector piece (40) and line piece (20) are pushed together for connection.

6. The energy transfer system as claimed in claim 5, characterized in that the groove (26) in the overlapping region of the sliding connection is formed in the region (28) of the reduced outside diameter of the respective cylindrical conductor (21, 22, 23) of the line piece (20).

7. The energy transfer system as claimed in one of the preceding claims, characterized in that annular pin insulators (32), preferably of cured epoxy resin, are pushed with a sliding fit onto the inner conductors (21, 22) of the line piece (20) and extend through the annular interspace between an inner conductor (21, 22) and the next outer conductor (22, 23), in order to ensure coaxial concentric securement of the conductors (21, 22, 23) in relation to one another.

8. The energy transfer system as claimed in claim 7, characterized in that the pin insulators (32) taper in the radial direction from the inside outward.

9. The energy transfer system as claimed in claim 8, characterized in that the pin insulators (32) are provided on their cylindrical inner and outer surfaces with a peripheral groove (34), into which a high-impedance, but conductive element (36) has been placed, in order in each case to short-circuit the gap between the conductor (21, 22) and the pin insulator (32).

10. The energy transfer system as claimed in one of the preceding claims, characterized in that annular bulkhead insulators (62), preferably of cured epoxy resin, have been pushed onto the inner conductors (21, 22; 41, 42) of the line piece (20) or connector piece (40) and completely fill the annular interspace between an inner conductor (21, 22; 41, 42) and the next outer conductor (22, 23; 42, 43), a peripheral groove (64) respectively being provided in the touching surfaces of the bulkhead insulators (62) and the adjacent conductors, into which groove a peripheral sealing ring (66) is respectively placed to form a gastight termination.

11. The energy transfer system as claimed in one of the preceding claims, characterized in that a connector piece for branching a line piece is formed from a connector piece (40) for connecting two line pieces and a T line piece (80) connected thereto, the cylindrical conductors (81, 82, 83) of which T line piece coincide in construction and dimensions with those of a line piece (20) and which T line piece has a stub in which a cylindrical conductor (81′, 82′, 83′) with the same diameter branches off from each cylindrical conductor (81, 82, 83).

12. The energy transfer system as claimed in one of the preceding claims, characterized in that there is, furthermore, an end piece (90), which coincides at one end in the construction of the concentric cylindrical conductors (91, 92, 93) with a connector piece (40) and is terminated at the other end by insulators (94).
